(19) United States
(12) Patent Application Publication
(10) Pub. No.: US 2015/0041609 A1
(43) Pub. Date: Feb. 12, 2015

(54) PORTABLE STAND FOR ELECTRONIC DEVICE AND EXTERNAL MONITOR

(71) Applicant: ERIC YISHUN LEE, GRANADA HILLS, CA (US)

(72) Inventor: ERIC YISHUN LEE, GRANADA HILLS, CA (US)

(21) Appl. No.: 14/451,750

(22) Filed: Aug. 5, 2014

Related U.S. Application Data
(60) Provisional application No. 62/000,006, filed on May 19, 2014.
(60) Provisional application No. 61/937,617, filed on Feb. 10, 2014.
(60) Provisional application No. 61/884,152, filed on Sep. 30, 2013.
(60) Provisional application No. 61/862,963, filed on Aug. 7, 2013.
(60) Provisional application No. 61/862,517, filed on Aug. 6, 2013.

(51) Int. Cl. F16M 11/00

(52) U.S. Cl. CPC F16M 11/00
USPC 248/447

(57) ABSTRACT

Some embodiments of the present disclosure include a portable stand for supporting an electronic device having a screen and an external monitor vertically about the screen of the electronic device. The stand may include a bottom panel configured to support the electronic device, a middle panel configured to removably and hingeably engage with the bottom panel, the middle panel extending upwards from the bottom panel, and the middle panel configured to substantially align with the screen of the electronic device, and a top panel configured to support an external monitor vertically above the screen of the electronic device, the top panel being configured to removably and hingeably engage with the middle panel, the top panel extending vertically upwards from the middle panel. The panels may engage using a plurality of knuckles and threaded screw rods. The stand may be configured to collapse in a trifold mechanism for storage purposes.

### RELATED APPLICATION

This application claims priority to provisional patent applications U.S. Ser. No. 61/862,517 filed on Aug. 6, 2013; U.S. Ser. No. 61/862,963 filed on Aug. 7, 2013; U.S. Ser. No. 61/884,152 filed Sep. 30, 2013; U.S. Ser. No. 61/937,617 filed Feb. 10, 2014; and U.S. Ser. No. 62/000,006 filed May 19, 2014, the entire contents of each of which is herein incorporated by reference.

### BACKGROUND

The embodiments herein relate generally to electronic device accessories, and more particularly, to portable stand for an electronic device and an external monitor.

The most optimal level to view a screen is at eye-level. Laptop stands allow users to view the laptop screen at eye-level, but require an external keyboard to ensure proper ergonomic postures. USB-powered external monitors are growing in popularity because of their portability and ability to be powered from the USB port of a laptop. Additionally, external monitors provide the user with dual screens, allowing the user to multitask more productively.

A common method to raise external monitors to the user's eye-level is by placing the USB-powered external monitor on top of items such of reams of paper, phone books, textbooks, and the like. This method eliminates the need for an external keyboard for users that prefer to view their screen at eye-level. However, this method causes desktop clutter and looks unprofessional. Additionally, the user constantly has to look side-to-side to view the external monitor, which can strain the neck over time.

Therefore, what is needed is a portable stand for an electronic device and an external monitor, wherein the external monitor is elevated above the screen of the electronic device.

### SUMMARY

Some embodiments of the present disclosure include a portable stand for supporting an electronic device having a screen and an external monitor vertically about the screen of the electronic device. The stand may include a bottom panel configured to support the electronic device, a middle panel configured to removably and hingeably engage with the bottom panel, the middle panel extending upwards from the bottom panel, and the middle panel configured to substantially align with the screen of the electronic device, and a top panel configured to support an external monitor vertically above the screen of the electronic device, the top panel being configured to removably and hingeably engage with the middle panel, the top panel extending vertically upwards from the middle panel. The panels may engage using a plurality of knuckles and threaded screw rods. The stand may be configured to collapse in a trifold mechanism for storage purposes.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention, displaying how a monitor and laptop may sit on the stand.

FIG. 2 is a back perspective view of one embodiment of the present invention.

FIG. 3 is an exploded view of one embodiment of the present invention.

FIG. 4 is a front view of one embodiment of the present invention.

FIG. 5 is a side view of one embodiment of the present invention.

FIG. 6 is a section view of one embodiment of the present invention, taken along line 6-6 in FIG. 1.

FIG. 7 is a section view of one embodiment of the present invention, taken along line 7-7 in FIG. 1.

FIG. 8 is a perspective view of one embodiment of the present invention, shown folded up.

FIG. 9 is a side view of one embodiment of the present invention, shown folded up.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to support an external monitor vertically above the monitor of an electronic device, while also supporting the electronic device and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Bottom Panel

2. Middle Panel

3. Top Panel

The various elements of the portable stand for supporting an external monitor vertically above a monitor of an electronic device, while also supporting the electronic device, of the present disclosure may be related in the following exemplary fashion. It is not intended to limit the scope or nature of the relationships between the various elements and the following examples are presented as illustrative examples only.

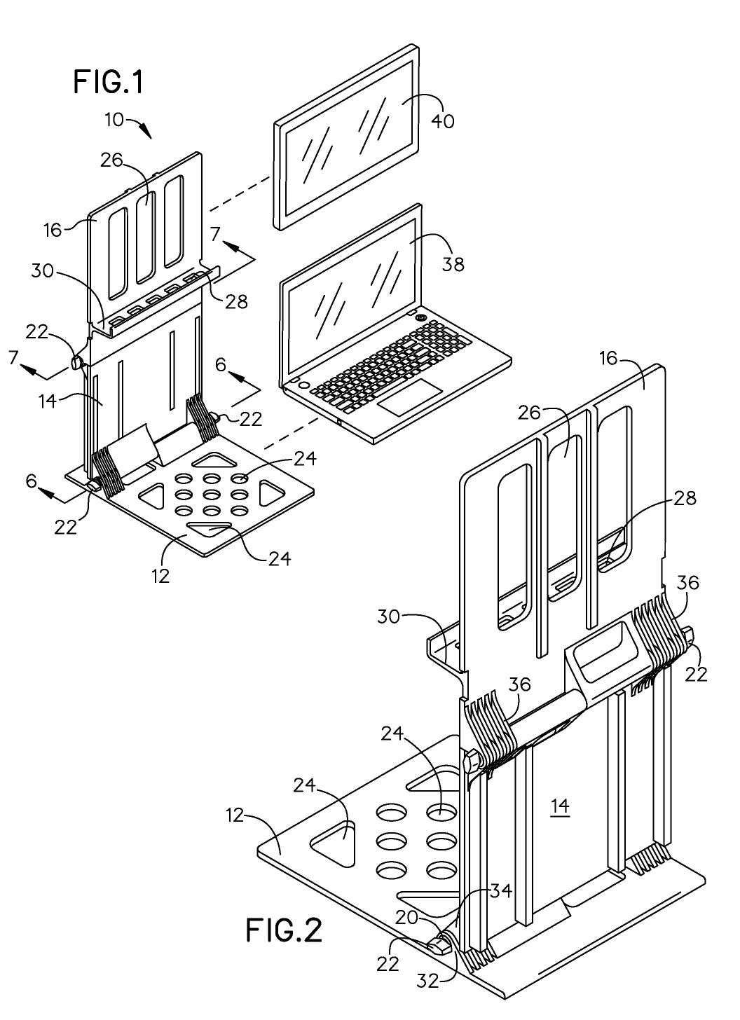

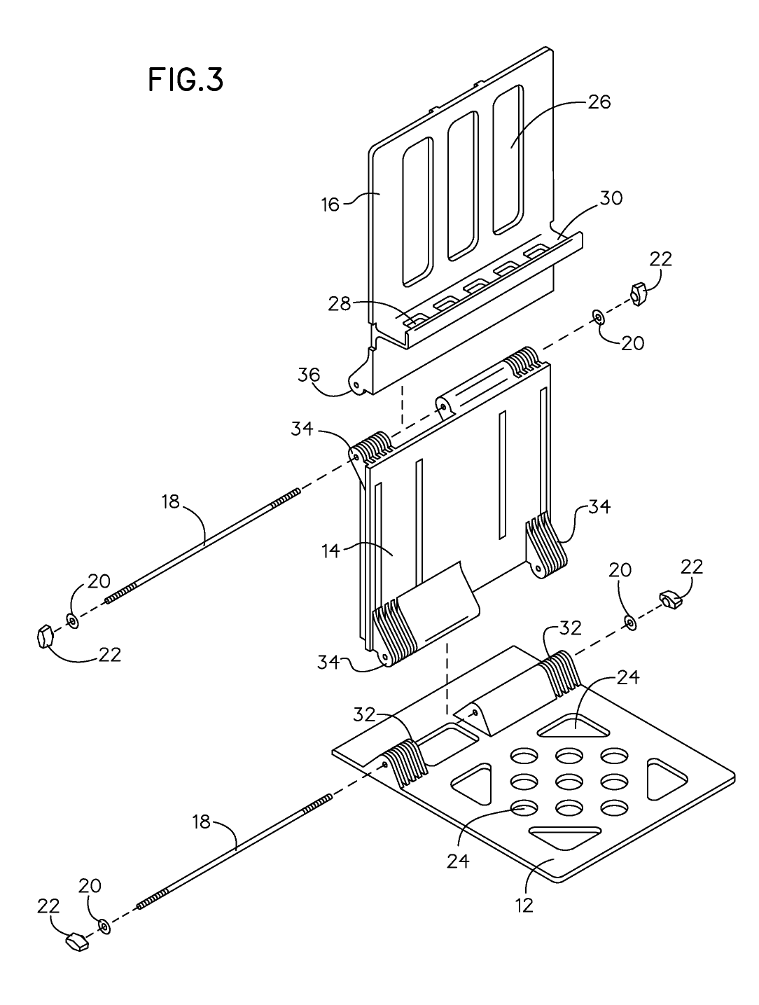

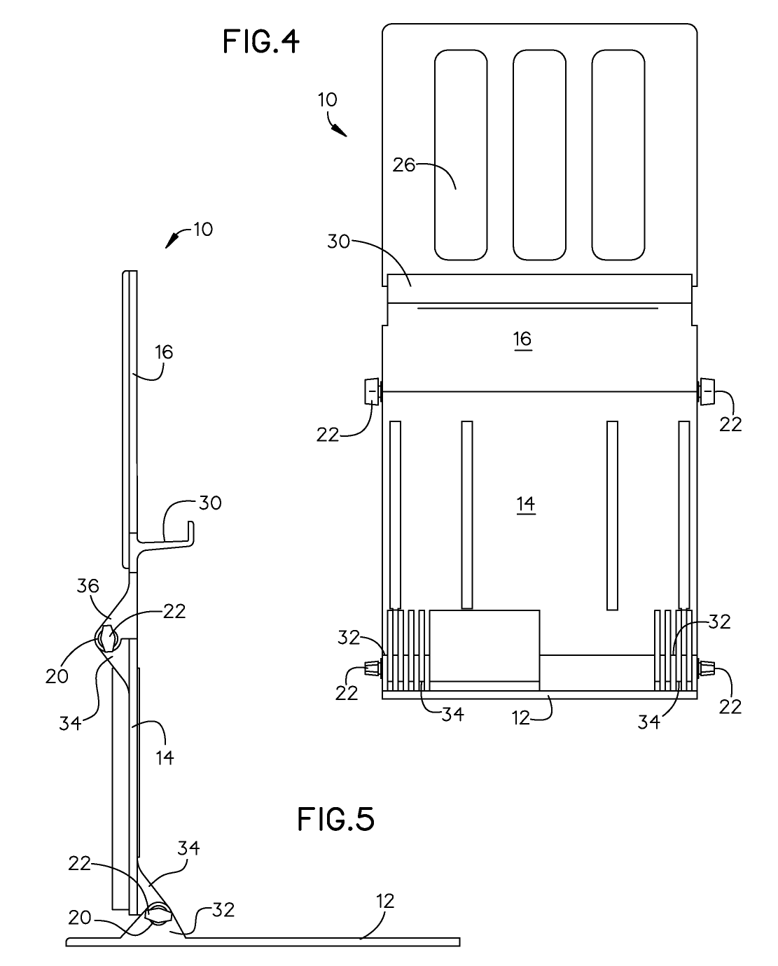

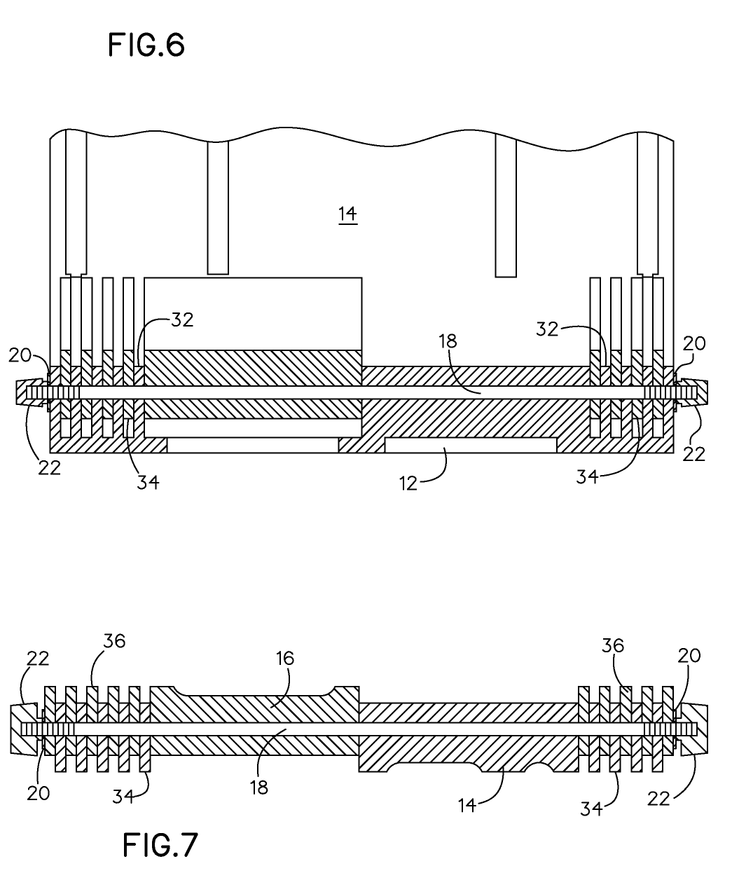

By way of example, and referring to FIGS. 1-9, some embodiments of the portable stand 10 of the present disclosure comprise a bottom panel 12 configured to support an electronic device, such as a laptop 38, a middle panel 14 configured to removably and hingeably engage with the bottom panel 12, and a top panel 16 configured to support an external monitor 40, the top panel being configured to removably and hingeably engage with the middle panel 14, wherein the top panel 16 engages with a surface of the middle panel 14 opposite a surface of the middle panel 14 that engages with the bottom panel 12. In embodiments, stand 10 may further comprise a channel 30 extending outwardly from the top panel 16, wherein the channel 30 is configured to support to the external monitor 40, as shown in FIG. 1.

The bottom panel 12 may comprise a plurality of vent holes 24, such that the stand 10 provides the electronic device with airflow to prevent the electronic device from overheating. For example, as shown in the figures, the bottom panel 12 may comprise a plurality of differently shaped vent holes 24, such as a number of circular vent holes 24 and a number of triangular vent holes 24. However, the number and shape of the vent holes may vary as desired. Extending upwardly from the bottom panel 12 may be a plurality of bottom panel knuckles 32, wherein the bottom panel knuckles are configured to engage with a plurality of middle panel knuckles 34 which may extend from the middle panel 14. For example, the bottom panel knuckles 32 and the middle panel knuckles 34 may engage as shown in FIGS. 1, 3, 4, and 6, wherein a threaded screw rod 18 may extend through an orifice in the knuckles 32, 34 resulting in the bottom panel 12 and the middle panel 14 being hingeably attached. The threaded screw rod 18 may be secured in place using a washer 20 and a friction knob 22 on either end of the threaded screw rod 18, such that the threaded screw rod 18 may not be removed from the knuckles 32, 34 without a user loosening the friction knobs 22.

As shown in FIG. 1, the bottom panel knuckles 32 may not extend from an outer surface of the bottom panel 12; rather, the bottom panel knuckles 32 may extend from an area on the surface of the bottom panel 12 a distance from the back edge of the bottom panel 12, such as about 0.5 to about 3 inches from the back edge of the bottom panel 12, such that the bottom panel 12 extends past the bottom panel knuckles 32 in two directions, wherein a smaller portion of the bottom panel 12 extends backwardly from the bottom panel knuckles 32. The portion of the bottom panel 12 that extends backwardly from the bottom panel knuckles 32 may help prevent the stand 10 from tipping over when in use.

The bottom panel 12 may have any size and shape suitable for supporting an electronic device, such as the keyboard of a laptop 38. For example, the bottom panel 12 may have a width of from about 8 to about 15 inches, and a length of from about 8 to about 15 inches.

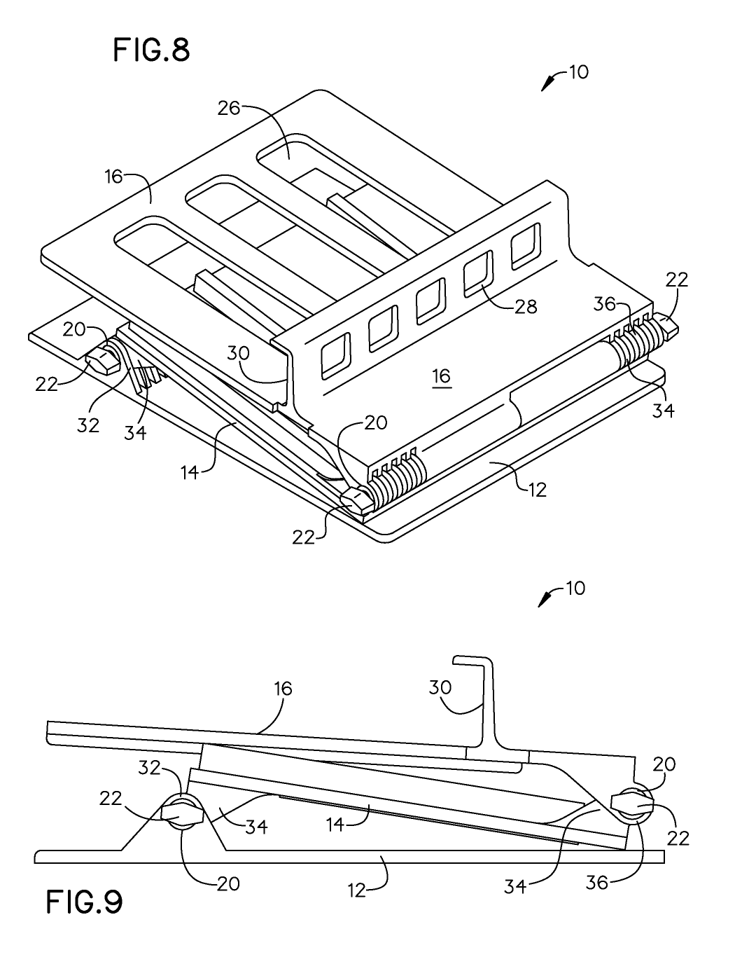

In embodiments, the middle panel 14 may comprise a first set of middle panel knuckles 34 configured to engage with the bottom panel knuckles 32 and a second set of middle panel knuckled 34 configured to engage with top panel knuckles 36, wherein the first set and the second set extend from opposite surfaces and sides of the middle panel 14 from one another. As described above, a threaded screw 18 may be configured to engage with the second set of middle panel knuckles 34 and the top panel knuckles 36 similar to how the threaded screw 18 engages with the first set of middle panel knuckles 34 and the bottom panel knuckles 32. As a result, the middle panel 14 may be hingeably attached to both the top panel 16 and the bottom panel 12. In some embodiments, the hinge attachment between the top panel 16 and the middle panel 14 may result in the top panel 16 being configured to fold against a back surface of the middle panel 14, whereas the hinge attachment between the bottom panel 12 and the middle panel 14 may result in the bottom panel 12 being configured to fold against a front surface of the middle panel 14, as shown in FIGS. 8 and 9. Thus, the stand 10 may collapse in a trifold mechanism.

The middle panel 14 may have any desired size and shape configured to align with a monitor on an electronic device, such as a laptop 38, as shown in FIG. 1. For example, in some embodiments, the middle panel 14 may be from about 12 to about 15 inches tall. In some embodiments, the middle panel 14 may comprise at least one cable management hole (not shown).

The top panel 16 may comprise a plurality of cable holes 26 and a channel 30 and top panel knuckles 26 extending therefrom. The cable holes 26 may have any size and shape such that a user may pass any cables from the external monitor 40 through the cable holes 26, as needed. The channel 30 may extend substantially perpendicularly outward from the surface of the top panel 16, such that the channel 30 comprises a support for the external monitor 40. The channel 30 may comprise a lip extending upwardly from a bottom surface of the channel 30, wherein the lip may be substantially parallel to the surface of the top panel from which the channel extends. In some embodiments, the bottom surface of the channel 30 may comprise a plurality of channel cable holes 28. The channel 30 may extend outwardly from the top panel 16 at any position such that the external monitor 40 may be supported vertically above the screen of the electronic device or laptop 38.

In embodiments, the top panel 16 may have any size and shape and, in some embodiments, is from about 8 to about 20 inches wide and from about 8 to about 14 inches tall. The channel may be from about 1 to about 2 inches deep, and the lip of the channel 30 may be from about ¼ to about 1.5 inches tall to prevent the external monitor 40 from falling forward.

The stand 10 of the present disclosure may collapse in a trifold mechanism, as shown in FIGS. 8 and 9, wherein the stand 10 may be locked into the collapsed position by folding the middle panel 14 and the top panel 16 downwards and then locking the panels into place using the friction knobs 22. For example, in each pair of friction knobs 22, a first friction knob may be rotated counter clockwise while the second friction knob may be simultaneously rotated clockwise, causing the panels to be locked into place.

To use the stand 10 of the present disclosure, a user may first place the bottom panel 12 on a surface and then fold the middle panel 14 upwards until it is at the desired angle, such as substantially perpendicular to the bottom panel 12. While holding the middle panel 14 upright, a user may lock the middle panel 14 into place by rotating a first friction knob 22 counter clockwise and a second friction knob 22 clockwise simultaneously, locking the middle panel 14 in place. A similar action may be taken with the top panel 16 such that the top panel 16 is locked into the desired position. A user may then place an electronic device, such as a laptop 38 on the bottom plate 12 with the screen of the laptop 38 aligned with the middle panel 14. An external monitor 40 may then be placed in the channel 30 on the top panel 16, wherein any cords associated with the external monitor may be fed through the channel cable holes 28 or the cable holes 26.

In alternate embodiments, the stand of the present invention may be a single, solid piece, wherein the bottom panel, the middle panel, and the top panel are unable to detach from one another and are also not hingeably attached. Rather, the bottom panel may flow directly into a middle panel, wherein a top panel folds downward from an upper surface of the middle panel, the top panel comprising a channel configured to hold an external monitor. In this embodiment, the angle of the panels may not be adjustable. In another embodiment, the bottom panel, the middle panel, and the top panel may all snap together, creating a stand suitable for holding an external monitor vertically above a monitor of a laptop.

The stand 10 of the present invention may be made of any material suitable to support a laptop and external monitor. In some embodiments, the stand 10 may be made of, for example, aluminum, acrylic, polycarbonate plastic, such as transparent polycarbonate plastic, or injection molded plastics

The device of the present invention may not just be limited to holding electronic devices and external monitors. For example, in some embodiments, instead of holding an external monitor and/or a laptop, the device may hold a book, a magazine, a tablet, any other reading or reference material that a user may wish to support with a stand.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A portable stand for supporting an electronic device having a screen and an external monitor vertically about the screen of the electronic device, the portable stand comprising:
a bottom panel configured to support the electronic device;
a middle panel configured to removably and hingeably engage with the bottom panel, the middle panel extending upwards from the bottom panel, and the middle panel configured to substantially align with the screen of the electronic device; and
a top panel configured to support an external monitor vertically above the screen of the electronic device, the top panel being configured to removably and hingeably engage with the middle panel, the top panel extending vertically upwards from the middle panel,
wherein the top panel engages with a surface of the middle panel opposite a surface of the middle panel that engages with the bottom panel.

2. The portable stand of claim 1, wherein:
the top panel comprises a channel extending substantially perpendicularly outwards from a surface of the top panel; and
the channel is configured to support the external monitor.

3. The portable stand of claim 2, wherein the channel comprises a lip extending upwards from a bottom surface of the channel, the lip being substantially parallel to the surface of the top panel from which the channel extends.

4. The stand of claim 1, wherein:
the bottom panel comprises a set of bottom panel knuckles extending from a surface of the bottom panel;
the top panel comprises a set of top panel knuckles extending from a surface of the bottom panel; and
the middle panel comprises a first set of middle panel knuckles configured to engage with the set of bottom panel knuckles and a second set of middle panel knuckles configured to engage with the set of top panel knuckles.

5. The portable stand of claim 4, wherein the set of bottom panel knuckles does not extend from an outer edge of the bottom panel.

6. The portable stand of claim 4, wherein a threaded screw knob extends through an orifice in each of the engaged sets of knuckles resulting in the panels being hingeably attached to one another.

7. The portable stand of claim 6, wherein each of the threaded screw rods are secured in place using a washer and a friction knob positioned on each end of the threaded screw rod.

8. The portable stand of claim 7, wherein each of the bottom panel, the middle panel, and the top panel is configured to be locked into a desired position by rotating a friction knob at a first end of the threaded screw rod counter clockwise while simultaneously rotating a friction knob at a second end of the threaded screw rod clockwise.

9. The portable stand of claim 1, wherein the portable stand is configured to collapse in a trifold mechanism, wherein the portable stand is locked into a collapsed position by folding the middle panel and the top panel downwards and then locking the panels into place using a plurality of friction knobs.

10. A portable stand for supporting an electronic device having a screen and an external monitor vertically about the screen of the electronic device, the portable stand comprising:
a bottom panel comprising a set of bottom panel knuckles extending from a surface of the bottom panel, the bottom panel being configured to support the electronic device;
a middle panel comprising a first set of middle panel knuckles and a second set of middle panel knuckles, the first set of middle panel knuckles configured to engage with the set of bottom panel knuckles, the middle panel extending upwards from the bottom panel, and the middle panel configured to substantially align with the screen of the electronic device; and
a top panel comprising a channel and a set of top panel knuckles extending from a surface of the top panel, wherein the channel is configured to support an external monitor vertically above the screen of the electronic device, the set of top panel knuckles is configured to engage with the second set of middle panel knuckles, and the top panel extends vertically upwards from the middle panel,
wherein:
the portable stand is configured to collapse in a trifold mechanism; and
the portable stand is locked into a collapsed position by folding the middle panel and the top panel downwards and locking the panels into place using a plurality of friction knobs.
